(19) United States
(12) Patent Application Publication
(10) Pub. No.: US 2008/0259749 A1
(43) Pub. Date: Oct. 23, 2008

(54) Recovery of Lost Track Focusing on an Optical Disc

(75) Inventors: Jeroen Arnoldus Leonardus Johannes Raaymakers, Eindhoven (NL); Martijn Van Der Maaden, Eindhoven (NL); Stefan Geusens, Houthalen (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/576,525

(22) PCT Filed: Sep. 22, 2005
(86) PCT No.: PCT/IB05/53119

§ 371 Date: Apr. 17, 2008

(30) Foreign Application Priority Data
Oct. 5, 2004 (EP) 04104867.9

(51) Int. Cl. G11B 7/00

(52) U.S. Cl. 369/44.13

(57) ABSTRACT

A method for restoring focusing of a laser beam on a track of an optical disc for reading or writing data from/to the track when the focusing of said beam onto said track has been lost, wherein two categories, A and B, of focus lost causes are defined, A being due to an external shock and B due to other reasons and wherein a focus re-capture is performed with the use of focus control information stored in a memory only for a category B focus lost.

The present invention refers to optical drives for reading or writing data from/to information carriers. Information carriers can be optical discs such as CD, DVD or Blu Ray discs. Particularly, the invention has as an object to restore the focusing of a laser beam on a track of an information carrier for reading or writing data from/to the track when the focusing of said beam onto said track for different reasons have been lost.

Digital information is read from an optical disk or written on an optical disc along a track on the optical disc by use of an optical drive. A focus actuator in the optical drive is used to focus a laser spot onto the optical disc. The laser spot is provided by a laser beam focused by means of an objective lens, which focuses the laser beam onto a data storing layer of the disc. As an example, a focusing actuator coil drives the objective lens so that the objective lens is focusing a focal point of the laser beam on the data storing layer of the disc. A second coil, a tracking actuator coil, drives the objective lens, so that the laser beam is traced along the track of the disc.

In an optical drive a servo system is used to focus the focal point of the laser beam, the laser spot, onto the data storing layer of the disc. A control loop for controlling said servo system is called the focus control loop. To guarantee a proper optical drive performance the focus control loop must be closed. An error signal for controlling the guidance of the laser beam in the servo system can be obtained from light reflected back from the data storing layer to a detector on a sledge carrying a light source for the laser beam.

To capture focus the actuator is moved towards the disc. During the movement towards the disc, the reflected signal, called central aperture (CA) is monitored. If the signal exceeds a certain threshold level the actuator is close to the focussing point and the focus error signal is then monitored.

However, the focus error signal containing information about the distance from the optimal focussing point is defined only a limited distance of a few μm around the optimal focus point of the beam on the track. If the tracking error exceeds this limit, closed loop operation in said servo system is not possible any longer. When this happens, it is called focus lost. Focus lost events can occur due to several reasons. In this description, the reasons for focus lost are grouped into two categories:

Category A: focus lost due to an external shock

Category B: focus lost due to other reasons, such as radial problems, scratches on the disc, black dots on the disc, small jumps of the sledge, etc.

Radial problems can occur due to surface irregularities of the disc, e.g. scratches, black dots or fingerprints. Also, if a small jump of the actuator is made on a disc with high radial eccentricity and the radially moved actuator hits its housing. In the latter case the friction between moving parts of the actuator and the housing (which are in contact) will result in a focus lost situation.

After a focus lost event the drive unit needs to recover the focus on the track, that is the focus control loop should be brought to a stable state again. This is called the focus re-capture. The entire sequence of detecting a focus lost event and to bring the drive back to a stable focus tracking state with the re-capture is called a focus recovery.

In prior art drives the focus recovery sequence is always the same, independent of the nature, that is the category, of the focus lost. In most drives a memory loop mechanism, called synchronized repetitive control (SRC) is used to store repetitive focus control information obtained from earlier disc rotations.

Publication WO 01/67444 (P1) describes a method to avoid focus lost, where two error signals are defined for slightly different locations on the disc, for example for a main spot and a satellite spot. By relying on information about differences between the two error signals, it is determined if a shock has occurred (the error signals are in this case almost identical) or if a scratch is present on the disc (the error signals are then shifted in time). Based on this detection, certain measures may be taken, e.g. if a shock has occurred the gain in the servo system can be increased.

U.S. Pat. No. 6,046,967 (P2) discloses a method suggesting a use of a non-linear gain in the servo system controlling the focusing of the laser beam. As a result a greater bandwidth is achieved in the servo system if the error is big. To counteract negative effects during a detected defect the non/linear gain circuit is replaced by a linear gain operation if a defect is detected.

A defect can be e.g. a scratch, black dot, fingerprint.

In publication P1 the idea of using two spots is essential. The system is then tracking during the entire reading/writing of the disc. Publication P2 discloses a well-known solution. Both publications, P1 and P2, describe measures to increase tracking performance, when the type of error causes (shock or scratch) is known. In addition P1 gives an example of how to discriminate between error causes, which is not possible in the disclosure shown in P2, which is limited to a description of the measure taken (switch between linear and non-linear gain) only. In both cases there is no differentiation between how to recover after the system has lost focus. The circuits of P1 and P2 simply try to eliminate focus recoveries.

Depending on the root cause of the focus lost event the optimal focus recovery sequence is different. For example, after an external shock (category A) the disc drive may be heavily moving. The repetitive focus control info (SRC) stored in a servo memory is changed by these disturbances. After the focus lost event the drive and the disc are still heavily disturbed.

One object of the invention is to suggest a method and a device for a simple detection of a category, i.e. a root-cause, of a focus lost event and for adapting a recovery algorithm after the lost focus associated with the detected category.

According to an aspect of the invention there is provided a method as specified in claim 1.

According to a further aspect of the invention there is provided an optical drive as specified in the independent optical drive claim comprising a device for performing the method of claim 1.

Further embodiments of the invention are disclosed in the subclaims.

After a category A focus lost event the drive and the disc are heavily disturbed as stated. In this situation the SRC memory content cannot be used anymore during focus re-capture. According to the invention the SRC is thus not used and the SRC-memory is reset. A delay may further be required in the control loop of the servo system to let the system (drive and disc) damp out the movements sufficiently before focus recapture. If necessary the disc rotational speed can be lowered or the sledge can be arranged to jump to an inner radius, where focus capture generally is more robust or other alternative measures could be taken, all suited to the specific category of focus lost

After a category B focus lost event the engine and the disc are not disturbed dynamically. The content of the focusing memory (SRC) is still valid because the SRC learning speed is not fast enough to react on the short time disturbances of category B. As a result it is possible to use the SRC-memory information to re-capture focus again during a focus recovery. A delay in the control loop is not required. A small jump (typically 1 mm) with the sledge carrying a light source of the laser beam radially inwards or outwards in relation to the disc to move the laser beam away from the defect is a further possibility to aid the recovery. An advantage provided with the method according to the invention is that the recovery sequence is faster and more robust compared to the recovery described for a category A focus lost. As in prior art devices the procedure for recovery after a focus lost is the same for all disturbances, this is a very valuable property from a customer point of view.

These and other aspects of the invention will be apparent from and elucidated with reference to the embodiment(s) described hereinafter.

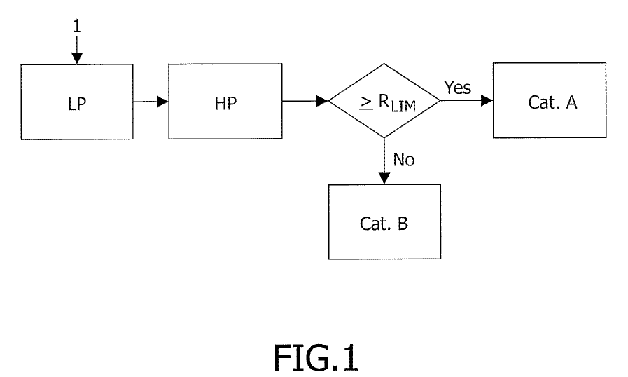

FIG. 1 discloses schematically an example of a flow chart for an evaluation of a focus lost cause.

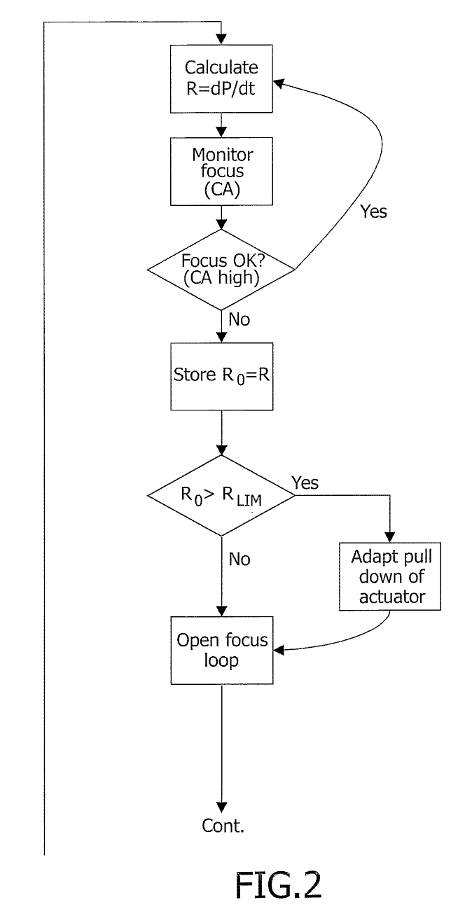

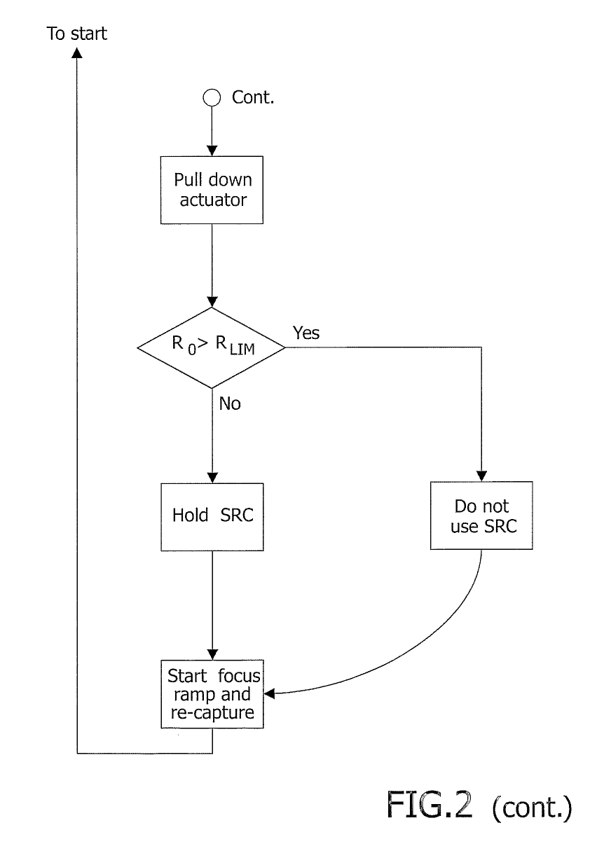

FIG. 2 discloses a flow chart for the algorithm used in the recovery of focusing according to an aspect of the invention.

A number of embodiments for performing the method according to the invention will be described in the following supported by the enclosed drawings.

In prior art devices the focus recovery is the same for both categories of lost focus causes. As a result the focus recovery is not always optimal. By the measures provided in this disclosure it is described a method for use of different recovery sequences based on the detected nature of the focus lost cause. The advantages of this method are described and summarized in respect of some critical issues.

### Delay Before a Focus Re-Capture can be Initiated

In prior art devices a delay before focus re-capture is required in all cases to cope with the possibility of an external shock. Also in category B cases this delay is performed. As a result the focus recovery will spend more time than necessary, which results in loss of throughput rate (performance).

According to the invention a delay is added to the control loop only if focus lost is due to a category A event.

### SRC-Memory Aided Focus Re-Capture

In prior art devices the SRC-memory content cannot be used, because the SRC-memory content can be corrupt due to a category A event.

According to the invention SRC-memory aided focus re-capture is not used after an external shock, but it is used for category B events. As a result the focus recovery is more robust and can be executed at all (high) disc rotational speeds.

### Decrease of Voltage Supplied to the Laser Beam Controlling Actuator to Prevent Scratches of the Actuator on the Disc.

In prior art a large voltage drop is used to cope with the, possible, high focus point movements due to the external shock. Due to the applied voltage drop the actuator is pulled down, away from the disc, strongly. The large voltage drop is also used for the category B events. This can lead to audible sounds (ticking sounds from the actuator hitting the housing).

According to the invention a large actuator voltage drop is used only after an external shock has occurred (category A). An advantage with the invention is that a more gentle voltage drop is sufficient.

Herein a voltage drop means reducing the voltage applied to the focus actuator coil. The focus actuator coil is connected such that increasing the applied voltage will increase the force on the actuator directed towards the disc, while reducing the applied voltage will reduce the force on the actuator directed towards the disc. Generally, reducing the voltage to pull the actuator away from the disc will lead to negative voltages applied to the focus actuator coils and therefore the force is such that the actuator will be directed away from the disc (the pull down).

Some of the essential features of the invention are that the drive is arranged to discriminate between the type of events that cause a focus lost and to adapt a focus recovery algorithm which corresponds to the specific type of such event.

Different options are possible to discriminate between the cause of the event (categories) leading to a focus lost. Two examples are described here:

1) Monitor the change of detected averaged focus power dissipation over a time period of at least some revolutions of the disc. If the power dissipation has changed before the focus lost event an external shock occurred. This monitoring may be performed by means of differentiating a detected averaged focus power dissipation (dP/dt), whereby the focus lost event is classified as category A if the value of the differentiated averaged focus power dissipation is greater than a predetermined level and classified as category B if the value of the differentiated averaged focus power dissipation is less or equal than said predetermined level.

2) Monitor the change of the contents of the SRC-memory over a time period of at least some revolutions of the disc. If the SRC content has changed before the focus lost event an external shock occurred. Said monitoring may be performed by means of checking the content of the SRC-memory over a fixed predetermined number of revolutions of the disc, whereby the focus lost event is classified as category A if the content of the SRC-memory has changed before the point of time of the focus lost and classified as category B if the content of the SRC-memory has substantially not changed.

After detection of a focus lost a re-capture scheme is used. As examples of embodiments of the invention, the following schemes can be used:

1) After a focus lost due to category A:

reset SRC-memory,

apply a voltage of P Volts to the actuator for typically 5 ms (note: this is called herein the large voltage drop), whereby the actuator moves to its position most far from the disc. By this it is meant here that the focus actuator, which carries the objective lens (and the focus coils), is pulled down strongly into its housing (the sledge) as a result of the applied voltage P. The aim is to prevent contact between disc and actuator. Contact between actuator and housing will occur, but that is not an issue because it will not lead to any damage of disc or drive.

wait 300 ms,

if required spin the disc down to a lower rotational speed or alternatively move the actuator closer to the centre of the disc (where focus re-capture is easier to perform),

start non-SRC-memory aided focus re-capture.

2) After a focus lost due to category B

apply a voltage of P′ Volts to the actuator for typically 5 ms (note: this is called herein the gentle voltage drop), whereby the actuator moves gently to a position away from the disc.

jump the sledge 1 mm in- or outwards in the radial direction of the disc,

start SRC-memory aided focus re-capture.

In FIG. 2 the sequence for a focus recovery is depicted, wherein it is shown that the change of focus power dissipation dP/dt is used to discriminate between focus lost root causes. The dissipation averaged over 1 revolution of the disc is constant because of the periodic nature of the focus movement. If it is not periodic, e.g. the averaged power changes, then some transient has occurred. This transient is assumed to originate from an external shock

The derivative dP/dt may be calculated by use of a detection circuit as shown in FIG. 1. In FIG. 1 the detected focusing power dissipation is sent as a corresponding signal 1 to a filter which measures the average power dissipation over exactly one revolution. The signal is then sent to a high pass filter HP, where the signal is differentiated. In a following step the differentiated signal is evaluated in an evaluator E, wherein a signal confirms to block A of the drive that the cause is classified as a category A focus lost if the derivative of the focus power dissipation is greater than a predetermined level. If the derivative instead is lower or equal to said predetermined level (called R_{LIM} in the figures) a signal is instead sent to block B of the drive indicating that the focus lost cause is of B category. Note: a sample of dP/dt to be used in evaluator E needs to be taken preferably just before or directly after the focus lost event.

A processor included in the optical drive is programmed to perform the algorithm and thereby control all steps of the methods as it is described above and depicted in the drawings.

The method according to the invention can be applied in all optical recording and writing devices, but it is especially useful for data drives with high shock requirements and/or Blu-ray disc drives with low free working distance. The free working distance (FWD) is the distance between the focus actuator and the optical disc. In conventional systems this distance was typically 1 mm, the trend is however, that this distance decreases.

According to the invention there is further provided a device for performing the focusing of the laser beam after a focus lost. Said device includes focusing means in the control loop for said focusing of the laser beam, a memory (SRC) for storing repetitive focus control information, detection means for detecting a focus lost cause, and a processor programmed to perform the algorithm indicated above

The terms comprising and including in the claims do not exclude other elements or steps. The articles a or an do not exclude a plurality of elements.

### DEFINITIONS

An external shock is a displacement and therefore velocity and acceleration applied to the housing of the drive. As a result the drive and disc will respond dynamically and extra control effort is required to keep the optical spot focussed onto the disc.

Dissipation is (P=Û2/R=Î2*R) generated in the focus actuator focus coils. These coils form the electro-magnetic motor for the actuator together with magnets. Generally the magnets are part of the fixed world, in this case the sledge, and the coils are part of the moving part of the actuator which also carries the objective lens. The focus dissipation can be measured in the drive by means of squaring the focus controller output and correcting the result for end stage drivers and focus coil resistance.

The SRC stores a signal which resembles the focus controller output of exactly one disc revolution. This signal is based on the last few revolutions of the disc. The adaptation speed, which is sometimes called learning speed, of the SRC can be adjusted by a parameter. A high adaptation speed means that the SRC contents closely resembles the latest revolution, a low adaptation speed means that more averaging is performed and the influence of earlier tracks is more dominant.

A laser beam controlling actuator (in the claims) has the same meaning as focus actuator.

1. A method for restoring focusing of a laser beam on a track of an information carrier for reading or writing data from/to a track on the information carrier when the focusing of said beam onto said track has been lost, comprising the steps of:
defining at least two types of focus lost causes: a category A being a focus lost due to an external shock bringing the laser beam out of focus of the track on the information carrier and category B being a focus lost due to other reasons,
controlling the focusing of the laser beam in a control loop,
storing repetitive focus control information in a memory (SRC),
detection of focus lost cause, category A or category B,
starting a focus re-capture with the use of the memory (SRC) information only for a category B focus lost after a focus lost event for restoring said focusing.

2. The method according to claim 1, further including the steps of:
arranging said detection of said focus lost cause by means of differentiating a detected average focus power dissipation (dP/dt),
classifying the focus lost event as category A if the value of the differentiated average focus power dissipation is greater than a predetermined level and
classifying the focus lost event as category B if the value of the differentiated average focus power dissipation is less or equal than said predetermined level.

3. The method according to claim 1, further including the steps of:
arranging said detection of said focus lost cause by means of checking the content of the SRC-memory over a time specified as a number of latest revolutions of the information carrier,
classifying the focus lost event as category A if the content of the SRC-memory has changed before the point of time of the focus lost,
classifying the focus lost event as category B if the content of the SRC-memory has substantially not changed.

4. The method according to claim 2, in case of a category A focus lost, further including at said re-capture stage the steps of:
resetting the SRC-memory,
pulling down the actuator.

5. The method according to claim 4, further including the step of:
waiting a fixed time interval before starting the focus re-capture.

6. The method according to claim 4, further including the step of:
presetting a voltage supplied to a laser beam controlling actuator by a predetermined voltage, P Volts, required to pull down the actuator strongly.

7. The method according to claim 5, further including the step of:
lowering the rotational speed of the information carrier before starting said re-capture.

8. The method according to claim 2, in case of a category B focus lost, further including at said re-capture stage the steps of:
moving a laser beam controlling actuator to its lowest position which means to a position most far from the information carrier,
jumping a radial sledge carrying said light source a predetermined small distance radially inwards or outwards in relation to the information carrier.

9. The method according to claim 8, further including the step of:
controlling said actuator position by presetting a voltage supplied to the laser beam controlling actuator by a predetermined voltage, P′ Volts, being a fraction of the predetermined voltage P used for the same purpose in a category A focus lost for achieving a gentle pull down of the actuator.

10. An optical drive for reading and/or writing information from/to an information carrier, comprising a device for restoring the focus of a laser beam on a track of the information carrier for reading or writing data from/to the track when the focusing of said beam onto said track has been lost, comprising:
focusing means in a control loop for said focusing of the laser beam,
a memory (SRC) for storing repetitive focus control information, characterized in that said device further comprises:
detection means for detecting a focus lost cause,
a processor programmed to perform an algorithm for defining at least two types of focus lost causes: a category A being a focus lost due to an external shock bringing the laser beam out of focus of the track on the information carrier and category B being a focus lost due to other reasons and for starting a focus re-capture with the use of the memory (SRC) information only for a category B focus lost after a focus lost event for restoring said focusing.

11. The optical drive according to claim 10, wherein said processor is further programmed to:
detect said focus lost cause by means of differentiating a detected average focus power dissipation (dP/dt),
classify the focus lost event as category A if the value of the differentiated average focus power dissipation is greater than a predetermined level and
classify the focus lost event as category B if the value of the differentiated average focus power dissipation is less or equal than said predetermined level.

12. The optical drive according to claim 10, wherein said processor is further programmed to:
detect said focus lost cause by means of checking the content of the SRC-memory over a time specified as a number of latest revolutions of the information carrier,
classify the focus lost event as category A if the content of the SRC-memory has changed before the point of time of the focus lost,
classify the focus lost event as category B if the content of the SRC-memory has substantially not changed.

13. The optical drive according to claim 10, wherein said processor, in case of a category A focus lost, is further at said re-capture stage programmed to:
reset the SRC-memory and pull down the actuator.
